(19) United States
(12) Patent Application Publication
(10) Pub. No.: US 2025/0071064 A1
(43) Pub. Date: Feb. 27, 2025

(54) SERVICE NETWORK EMPLOYING REINFORCEMENT LEARNING BASED GLOBAL LOAD BALANCING

(71) Applicant: Avesha, Inc., Chelmsford, MA (US)

(72) Inventors: Raj Nair, Lexington, MA (US); Prasad Dorbala, Lexington, MA (US); Eric Peterson, Carlisle, MA (US); Sai Koti Reddy Danda, Narasaraopeta, A.P. (IN); Raghuram Bharadwaj Diddigi, Bengaluru (IN); Prabhudev Navali, Westford, MA (US); Dheeraj Ravula, Alpharetta, GA (US)

(21) Appl. No.: 18/813,554

(22) Filed: Aug. 23, 2024

Related U.S. Application Data
(60) Provisional application No. 63/534,624, filed on Aug. 25, 2023.

(51) Int. Cl. H04L 47/125; H04L 41/16; H04L 47/24; H04L 67/101

(52) U.S. Cl. CPC H04L 47/125; H04L 41/16; H04L 47/24; H04L 67/101

(57) ABSTRACT

In a technique for directing network traffic to distribute client service requests among a set of service clusters of a service network, capacity and performance information is regularly obtained for the service clusters and provided to a trained reinforcement-learning (RL) model that integrates learned request-distribution and reward information for the service network. The RL model is operated to regularly update recommendation values for directing the client service requests to the service clusters, and updated recommendation values are regularly provided to a traffic director which directs network traffic at least partly based on the regularly provided updated recommendation values. The traffic director may be realized by a Domain Name System (DNS) server, having an ability to select among candidate service clusters based on weight values reported by the RL model.

### BACKGROUND

The invention is related to the field of distributed services in computer networks, and in particular to techniques for load balancing (also referred to as traffic management) of client requests or workloads across geographically distributed backend servers/services.

### SUMMARY

Methods and apparatus are disclosed for directing network traffic to distribute client service requests among a set of service clusters of a service network. Respective capacity and performance information is regularly obtained for each of the service clusters and provided to a trained reinforcement-learning (RL) model that integrates learned request-distribution and reward information for the service network. The RL model is operated to regularly update recommendation values for directing the client service requests to the respective service clusters, and regularly providing updated recommendation values to a traffic director to influence traffic-directing thereby. The traffic director directs network traffic at least partly based on the regularly provided updated recommendation values. In one embodiment, a traffic director is realized by a Domain Name System (DNS) server, which has an ability to select from among a set of candidate service clusters based on respective weight values that are reported to the server by the RL model.

### BRIEF DESCRIPTION OF THE DRAWINGS

The foregoing and other objects, features and advantages will be apparent from the following description of embodiments of the invention, as illustrated in the accompanying drawings in which like reference characters refer to the same parts throughout the different views.

FIG. 1 is a schematic diagram of a service network incorporating a smart global load balancer (GLB) for service requests to service clusters;

FIG. 2 is a schematic diagram of a service network incorporating a smart global load balancer (GLB) for deployment of graphical processing unit (GPU) based workloads;

FIG. 3 is a simplified schematic diagram illustrating weight-based load distribution for two clusters using Domain Name System (DNS);

FIGS. 4-6 are plots of workload over time for two geographically separated clusters in three operating scenarios;

FIG. 7 is a schematic illustration of inputs and outputs for an RL-GLB;

FIG. 8 is a detailed block diagram of an RL-GLB instance in one embodiment;

FIG. 9 is a more detailed illustration of inputs and outputs for an RL-GLB; and

FIG. 10 is a simplified flow diagram of high-level operation of the smart GLB technique.

### DETAILED DESCRIPTION

### Overview

The term global load balancing (GLB) (or also referred to as global traffic management (GTM)) refers to distribution of client requests or workloads across geographically distributed backend servers/services (compute/GPU/etc. resources), such as may be deployed in distributed Kubernetes clusters.

Forms of load balancing are known that utilize domain name system (DNS) based load balancing or a technique known as Anycast. Anycast is used to direct traffic among service instantiations that are distributed in several locations. Anycast will associate a single IP address with that service and cause all incoming traffic to be directed to the “nearest” (in network routing terms) service instance.

DNS based load balancing is used when a finer control over the traffic distribution is needed across multiple locations/clusters due to a variety of factors beyond simple network distance, e.g., network latency, service latency, overall service response time, throughput, resource utilization, etc. DNS based global load balancing (or global traffic management) provides mechanisms to direct traffic with greater degree of control than the Anycast based load balancing.

A smart GLB (Smart Global Load Balancer) as disclosed herein further extends this greater control over the traffic distribution using Reinforcement Learning (RL) based global load balancing. RL based GLB/GTM uses a trained RL model to make intelligent sequential decisions that are dynamic in nature and can improve overall performance. An RL model is trained on historic data (metrics/logs/resources/latency/calendar events/events/geolocation/policies/etc.) and learns complex traffic and loading patterns. Combined with a set of AI, machine learning and Deep learning algorithms, a disclosed solution uses Deep RL algorithm (including Deep Q-Learning algorithm) to handle a large/infinite number of configurations. The solution is adaptive in nature and can quickly adapt to noise in the system that may come from factors beyond a service provider's control.

The RL-GLB (RL-GTM) can take into account many factors such as: network latency, service latency, minimize service response time, maximize throughput, optimize resource utilization, avoid overloading services in one cluster, redundancy, availability, high-availability, data-gravity, governance, geolocation info, custom service/data access policies, proximity (lower-latency) to data or users, or access to scalable infrastructure, resource loading, cluster metrics, service metrics, application metrics, GPU metrics, GPU loading, GPU access policies etc. Both historical and real-time data is used with the RL algorithms.

The directing of the traffic to different clusters is done using DNS-specifically by dynamic use of weights in DNS-based on latency, data gravity, geo-location, governance etc. This is a global LB that may operate in a functional layer above other load balancers in the system. Thus, for example, each cluster may also have its own internal load balancer for distributing requests among cluster resources (servers, pods, etc.), while the GLB operates at a broader level to direct requests among different clusters.

### Embodiments

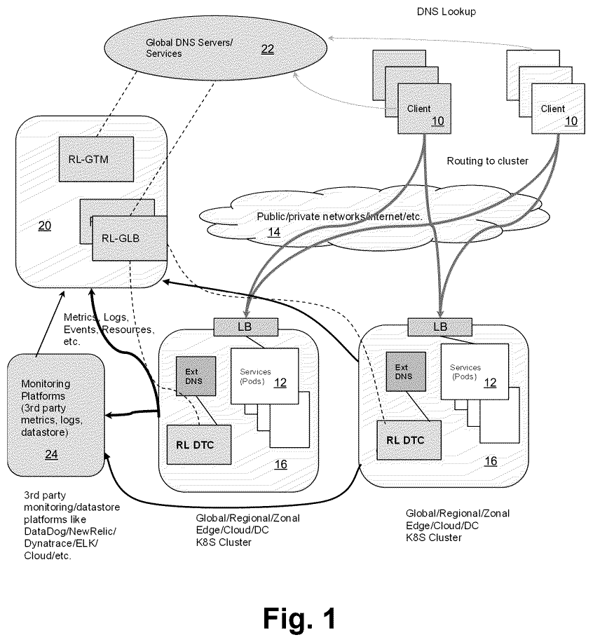

FIG. 1 shows an example smart-GLB system deployment with RL-GLB for microservices. At a high level, this is a service deployment in which a plurality of client machines (clients) 10 access microservices (more generally services) 12 via a wide-area network 14, the services 12 being provided in respective compute clusters 16, e.g., Kubernetes clusters. Each cluster 16 includes a respective local load balancer LB, dynamic traffic controller RL DTC and external DNS component Ext DNS. The system further includes a global RL-based platform 20 including multiple instances of RL-based systems shown as RL-GTM and RL-GLB, a set of global DNS servers/services 22, and one or more monitoring platforms 24 used for gathering operating data in the form of metrics, logs, datastore, etc. The RL-GTM and RL-GLB systems execution instances (i.e., service instances) of an RL-GTM/GLB application, for which details are described further below.

In the arrangement of FIG. 1, training component of the RL platform 20 train RL algorithms (inferencing) to make intelligent sequential decision that are dynamic in nature and maximizes overall performance. Certain details are described below. Load balancing decisions and actions of the RL-GLB/RL-GTM instances may be based on various operating data including, for example, service metrics, application metrics, cluster metrics, latency, cluster/service resource utilization, policies, data gravity, client/cluster geolocation info, governance, performance, custom policies, custom configuration, etc.

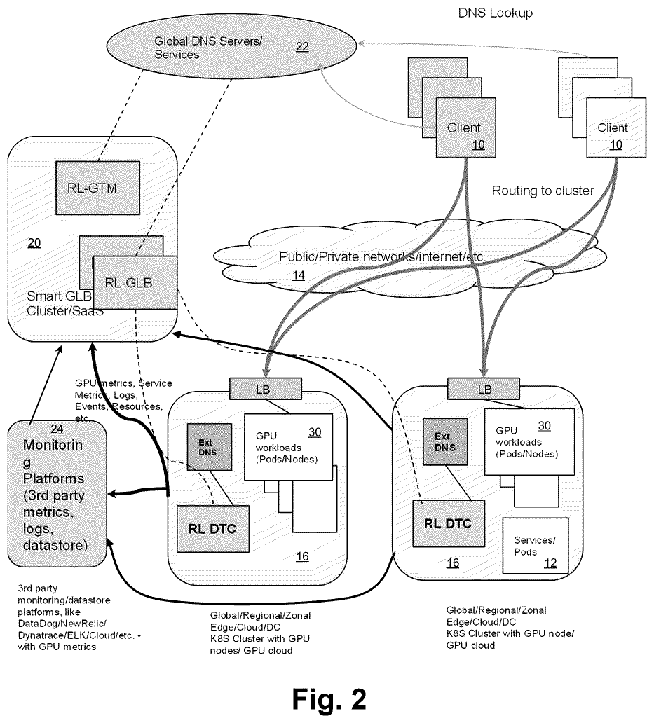

FIG. 2 shows an example smart-GLB deployment with RL-GLB for GPU workloads. Overall, the arrangement is like that of FIG. 1, with GPU/workloads 30 being the cluster-based components for which load balancing is performed. As shown for one of the clusters 16, a given cluster 16 may include services 12 in addition to GPU/workloads 30. Example GPU workloads include services/applications for inference, analytical, ETL, streaming, etc.

In the arrangement of FIG. 2, load balancing decisions and actions of the RL-GLB/RL-GTM may be based on various operating data including, for example, GPU metrics, GPU workload access policies, service metrics, application metrics, cluster metrics, latency, cluster/service resource utilization, policies, data gravity, client/cluster geolocation info, governance, performance, custom policies, custom configuration, etc.

There are a variety of other potential deployment models for distributing applications/services across multiple clusters. In one embodiment, the clusters may be deployed across multiple regions, zones, and/or edge locations of a single cloud provider, such as Amazon Web Services (AWS), Google Cloud (GCP), Azure, OCI, OpenShift, IBM, Akamai, etc.

In one embodiment, clusters may be deployed across multiple clouds—multiple regions, zones, edge locations of one or more cloud providers-like AWS, GCP, Azure, OCI, OpenShift, IBM, Akamai/Linode Cloud, etc.

In one embodiment, the clusters may be deployed across multiple clouds and hybrid clouds, data centers, on-premises data centers, enterprise data centers/sites, edge clouds, edge data centers—multiple regions, zones, edge locations of one or more cloud providers—like AWS, GCP, Azure, OCI, OpenShift, IBM, Akamai, etc., edge cloud providers like Equinix, PhoenixNAP, CoxEdge, etc. Private/Public 5G access data centers, clouds.

The RL-GLB platform 20 may be deployed in one or more cloud environments or one or more data centers. It may also be deployed in an air-gapped environment. The platform may be deployed as a SaaS on a cloud Kubernetes environment or cloud services-based environment.

In one embodiment, metrics for the RL-GLB/RL-GTM are ingested from the clusters 16 via mechanisms such as open telemetry, Prometheus, KSM, state metrics, application metrics, node metrics, service level metrics and service mesh metrics, etc. The metrics can include GPU metrics, GPU loading data, GPU application metrics and GPU/compute/cluster resource utilization metrics.

The cluster metrics may be ingested to 3rd party monitoring platforms 24 such as Datadog, NewRelic, Prometheus, Dynatrace, Cisco FSO, ELK, Elastic, SumoLogic, AppDynamics, Oracle APM, Akamai APM, Apdex, Microsoft Application Insights, etc. The Smart GLB platform 20 may ingest metrics/logs/etc. data from such external monitoring platforms 24 in addition to metrics/logs/etc. directly from the clusters 16.

In one embodiment, clusters 16 may consist of Kubernetes nodes or VM nodes (VM clusters) or combination of Kubernetes and VM nodes (VM clusters).

In one embodiment, the clusters 16 may be part of a specialized arrangement referred to as KubeSlice—application slices or tenant slices. The clusters 16 and one or more namespaces/services may be associated with a slice. A cluster 16 and associated namespaces may be part of one or more slices. The namespaces/services are managed by the KubeSlice platform.

Workloads may be migrated to separate locations to get a better customer experience or service-level agreement or service-level objective (SLA/SLO) in conjunction with the Smart GLB, where in one embodiment the KubeSlice can be utilized for workload migration. Migration might be needed due to resource constraints, high availability policies, disaster recovery policies, outages, and resource cost objectives as well.

In one embodiment, the clusters 16 and associated services/applications may be managed by a specialized platform referred to as Smart Scaler.

In one embodiment the clusters 16 and associated namespaces/services (that are part of the Smart GLB) may be part of the KubeSlice slice and the services may be auto scaled by the Smart Scaler platform (using a RL based auto-scaler).

In one embodiment, the DNS-based load balancing application may be deployed across global regions/zones by one or more DNS service providers. Typical network protocols include HTTP/HTTP, TCP, GRPC, UDP, IP, and typical traffic types include HTTP/HTTPS, UDP/TCP, GRPC, Web APIs, GPU based services APIs etc.

Generally, Global Load Balancing or Global Traffic Management (GTM) is an advanced technology that focuses on providing intelligent DNS-based traffic routing and management across multiple locations or data centers. GTM/GLB goes beyond basic load balancing to consider various factors, including network conditions, server health, and geographic proximity, to direct traffic in the most optimal way.
1. **Load Distribution**: It evenly distributes incoming traffic to multiple backend servers or data centers, ensuring even workloads and preventing any single server from being overwhelmed.
2. **High Availability**: provide failover capabilities, redirecting traffic to healthy servers in case of server or data center failures, thereby enhancing the overall availability of services.
3. **Performance Optimization**: can route traffic based on factors like server health, response times, and server capacity, helping to optimize the user experience.
4. **Advanced DNS Routing**: leverages DNS to direct users to the most suitable data center based on factors like server load, latency, and network health. It can make real-time routing decisions to ensure the best user experience.
5. **Geographical Load Balancing**: excels at geographical load balancing, considering users' geographic locations and routing them to the closest or best-performing data center.
6. **Failover and Disaster Recovery**: offer failover and disaster recovery capabilities, ensuring service availability even in the face of data center failures.
7. **Traffic Steering**: allows for more intelligent traffic steering based on a combination of factors, offering a higher degree of flexibility and optimization compared to traditional load balancing.
8. **Lowest Cost**: allow for selecting among various locations the ones that offer the lowest cost for running a workload while meeting the SLO/SLA.
9. **Fairness**: select locations for workloads for certain applications such as gaming or stock trading, where the criterion is to offer a more balanced and equitable degree of service for participants involved over a duty period, where the period can be the duration of a game or a stock trading session among other such latency-sensitive activities.

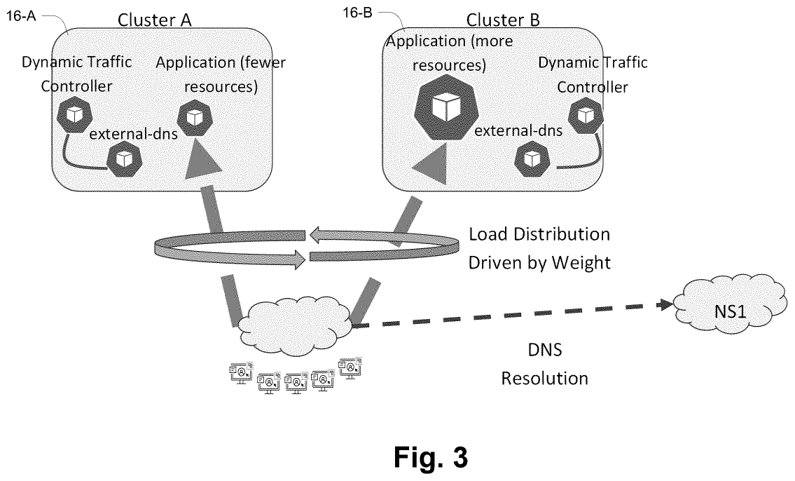

FIG. 3 is a simplified schematic illustration of key features of the disclosed technique. Along with advertising information regarding where a service is present, the RL-GLB provides controls to influence the traffic that is directed toward each service site. When advertising a service in a cluster 16, GLB can also advertise a “weight” attribute. Weight is used to provide a relative sense of how ready this site is to accept incoming traffic for that service. If sites A and B (shown in FIG. 3 as cluster A 16-A and cluster B 16-B respectively) both advertise a weight of 100, they are both equally ready to accept their full load. If site A advertises a weight of 100 and site B advertises a weight of 50, site A is ready to accept twice the load being sent to B. DNS provider NS1 (included in DNS services 22 of FIG. 1) is capable recognizing the weight attribute and using it to respond to DNS resolution requests. It does so in proportion to the ability of each cluster 16 to handle the additional load, as indicated by the weight values reported by RL-GLB.

An operator can configure weights either statically or dynamically. Static weight assignments may be used for longer-term control of the distribution of services (e.g., to drain load away from a cluster 16 ahead of scheduled downtime). Dynamic weight calculation can be enabled by configuring the RL-DTC, which then monitors the load of a service against configured resource constraints and dynamically adjusts the application weight according to how close the application is to reaching its maximum capacity. In this way, rather than allowing a given cluster 16 to become overloaded (with corresponding errors to end users), RL-GLB works with NS1 to direct traffic toward other clusters 16 with additional capacity.

For static association of IP addresses with DNS names, name to IP mappings are configured by an operator for any service (even those not in Kubernetes).

For dynamic association of IP addresses with DNS names, these are created as Kubernetes assigns new service/node IP addresses as applications migrate or nodes change within a cluster 16.

A given service is advertised from multiple clusters 16 so the DNS provider may load balance among the available set. The association of a weight with each name/IP mapping guides the DNS provider to balance the distribution of its responses to favor one site/cluster 16 over another. Dynamically updating the “weight” based on cluster loading allows the DNS provider to steer more/less traffic to a given cluster.

In the presently disclosed technique, reinforcement learning (RL) is utilized to better capture the operation and performance characteristics of applications deployed in single and multiple clusters 16. The knowledge is used to direct incoming traffic toward the cluster(s) 16 that offer the “best” experience (depending on definition of “best” . . . e.g., quickest response time, lowest cost, fewest errors, etc.).

In one embodiment, overall operation may be as follows:
1. Read in a file that describes all the microservices 12 that make up an application, and review the operation of that service
2. Observe the application behavior to determine if there are resource limitations of the cluster 16 (is there an upper bound on the number of nodes available for use, IP addresses, memory, other constrained resource)
3. Obtain one or more feeds reporting the historical and ongoing status of the application on this cluster or combining feeds for multiple clusters. As indicated above, these feeds can be provided by monitoring platforms 24. Examples statuses include transaction rate, error rate, transaction latency (within the cluster), resource loading (CPU, memory, etc. relative to the resources available to the application and its microservices).
4. Then use the feed data to produce a level of “goodness” of each cluster that can be reflected in the weight that is advertised to DNS providers 22. A non-RL DTC weight calculation algorithm is described below as an illustrative example. RL-GLB may also use a range between a lower threshold and upper threshold, in which (1) below the lower threshold the service should appear as “fully available”, (2) above the upper threshold the service should only be used as a “last resort”, and (3) between the lower and upper thresholds relative weighting should take place.

The Dynamic Traffic Controller has two user-adjustable thresholds to mark the point at which the weight should begin to decrease from 100 and the point at which the weight should be 1. The Dynamic Traffic Controller then calculates the weight based on the current usage value and the two thresholds. Note that a weight of 0 means “do not send traffic to this service” and is reserved for failure conditions.

An example is used to illustrate. The two thresholds are set at 60 and 90. If there is current usage of 60%, the weight remains at 100. If current usage is 70%, the weight is 67. If current usage is 90%, the weight is 1.

In another example, if there are thresholds of 50 and 80, then with a usage of 65% the weight is 50. The weight can be calculated as follows:

weight=100−[(current usage-low-threshold)/(high-threshold-low-threshold)*100]

In this example, weight in the range of 0 (minimum) to 100 (maximum) are used. Other ranges may be used. At least some known implementations of DNS (including NS1 and perhaps AWS Rt 53) allow weights greater than 100. The value between the brackets is a range-weighted measure of current usage above threshold.

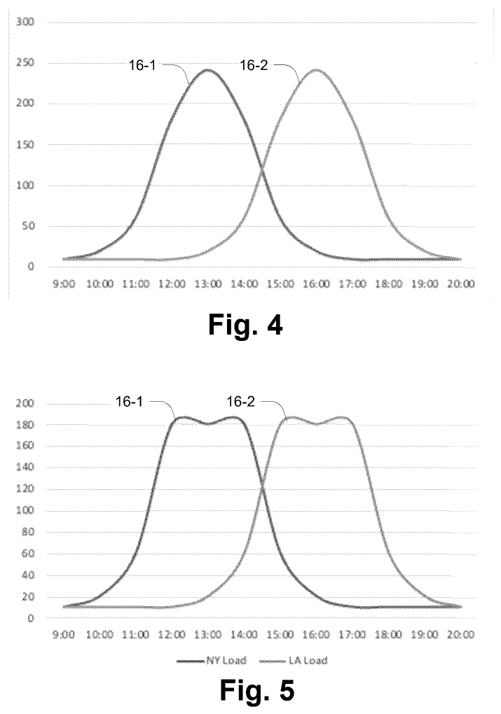

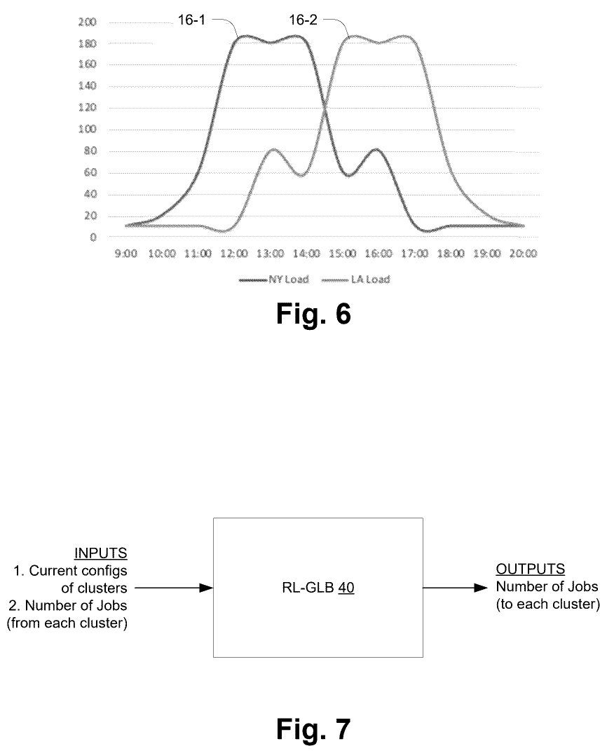

FIGS. 4-6 are used to illustrate load-adjusting behavior of the system. These are plots of load versus times for two clusters 16-1, 16-2 in time zones separated by 3 hours, such as East coast and West coast US. The loads exhibit high regional traffic from 9-5 o'clock every day, peaking at about 1 PM daily. FIG. 4 shows what the requested loads may look like. FIG. 5 shows the actual resulting loads when resources are limited in each location to a maximum capacity of 180, in the absence of any load balancing across the two systems. The hard limit at 180 means that user requests are dropped (not granted) at peak times. FIG. 6 shows the effect with load balancing in place. At the respective mid-day peaks, the excess requested load at one cluster is shunted to the other, so that all requests are handled without getting dropped.

### Smart Global Load Balancing Details

The following simplified example illustrates an important aspect of global load balancing as performed by RL-GLB/RL-GTM.

Consider two clusters 16, identified as “Fremont” and “Newark”. At 9:00 AM, 100 user requests are received, and the respective CPU utilizations at that time are Fremont 60%, Newark 40%.

Based on the lower utilization of Newark, one way of routing the jobs could be to route more jobs, e.g., 80, to Newark, and the balance 20 to Fremont. This might result in the following configurations at 10:00 AM:
CPU utilization of Fremont at 10:00 AM: 50%
CPU utilization of Newark at 10:00 AM: 50%

Then if at 10:00 AM another 300 jobs are received, and these are equally routed to the two systems, then the configuration might change to the following:
CPU utilization of Fremont at 11:00 AM: 80%
CPU utilization of Newark at 11:00 AM: 80%

In an alternative scenario, the initial routing at 9:00 AM could have been to route 80 jobs to Fremont instead (and 20 to Newark). Then at 10:00 AM, the following configuration might result:
CPU utilization of Fremont at 10:00 AM: 70%
CPU utilization of Newark at 10:00 AM: 20%

Then at 10:00 AM, routing 250 jobs to Newark might result in the following:
CPU utilization of Fremont at 11:00 AM: 75%
CPU utilization of Newark at 11:00 AM: 75%

The above is a better configuration than in the first scenario.

The above example illustrates that by making smarter load-balancing decisions (based on more than just current loading, for example), better performance over a longer term can be achieved. This can be done by using a trained RL algorithm to make intelligent sequential decisions that are dynamic in nature and tend to maximize overall performance. The algorithm is trained on historical data and learns complex patterns. Combined with artificial neural networks, a solution referred to as Deep Q-Learning can handle large/infinite number of configurations. The solution is adaptive in nature and can quickly adapt to any noise in the system.

FIG. 7 shows inputs and outputs for an RL-GLB instance 40 in one embodiment. As inputs, it receives a stream of samples of two values: (1) the current configurations of the respective clusters 16, and (2) the number of jobs being handled by each of the respective clusters 16. As outputs, it generates a stream of job-assignment values, each specifying the numbers of jobs to be assigned to the respective clusters 16.

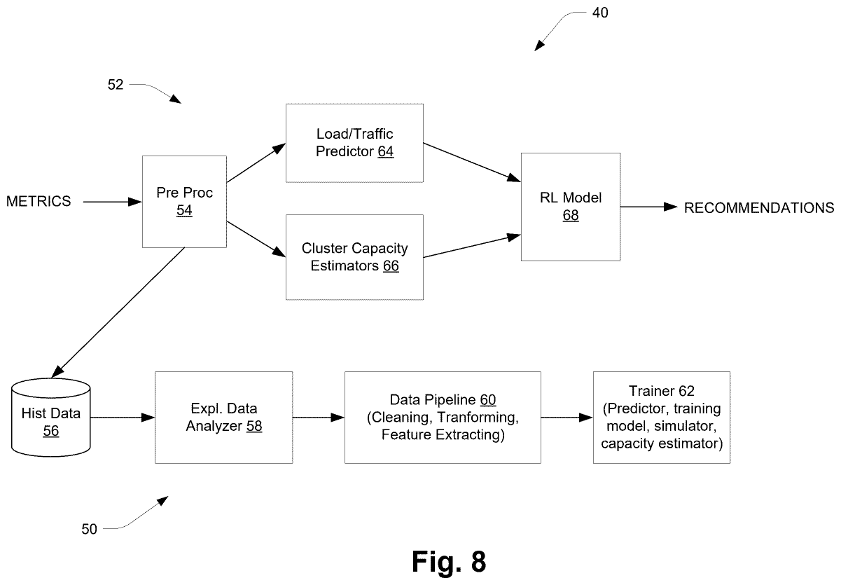

FIG. 8 is a block diagram of internals of an RL-GLB instance 40. Overall, it includes a training system/pipeline 50 and an inference system/pipeline 52.

The training system/pipeline 50 includes a Metrics Ingestion subsystem with a pre-processor 54 that performs metrics preprocessing as well as metrics transformation. Pre-processed metrics are stored in a historic data store 56 for use by the training pipeline. The pipeline 50 further includes an exploratory data analyzer 58 and a data pipeline 60 that performs Data Cleaning, Data Transformations, Feature Extraction, Feature Selection, etc. Finally, it includes a trainer 62 that executes one or more predictors, training models, simulations, and capacity estimator, as well as model checkpointing. Models include:
Machine Learning models (Linear/Polynomial regression, LASSO, Tf-idf, enet etc.)
Time Series models (ARIMA etc.)
Deep Learning models (LSTM, CNNs etc.)
Reward Modeling (SLOs and Cost objectives)
RL models (PPO, DQN-learning etc.)
Ensemble models (XGBoost, Gradient Boost, Bagging, Random Forests etc.)
Combination of any three

The Inference system/pipeline 52 also includes the metrics ingestion system with preprocessor 54 and inference components including Load/Traffic Predictor(s) 64, Capacity Estimation Models 66, and Reinforcement Learning (RL) model(s) 68. Inference models can include:
Machine Learning models (Linear/Polynomial regression, LASSO, Tf-idf, enet etc.)
Time Series models (ARIMA etc.)
Deep Learning models (LSTM, CNNs etc.)
RL models (PPO, DQN-learning etc.)
Ensemble models
Combination of any three

In operation of the Training System/Pipeline 50, service network metrics and service cluster metrics are ingested to Metrics ingestion system, which performs metrics preprocessing and metrics transformations like format, datatypes and unit conversions, offsets, etc. The pre-processed metrics are provided to the data pipeline 60 which performs data cleaning, data transformations like augmentations, and training set formations for AI models. Once the data is converted into the required formats, feature extraction and feature selections are done.

The trainer 62 includes a simulation system which is constructed based on the historical data 56 collected from the service clusters and service network metrics. AI model pipeline involves RL model and one or more ML, DL and Time series models. Ensemble of models are included in the system. A load traffic predictor consists of Machine Learning models (Linear/Polynomial regression, LASSO, enet etc.), Time Series models (ARIMA etc.) and Deep Learning models (LSTM, CNNs etc.). Capacity estimation models also include ML and DL models for predicting the service network and service cluster behaviors and patterns.

RL models are trained against constrained objectives like SLOs and Cost. Training considers the topology of the service network and service clusters. The model needs to decide the weights for the Load balancing system in such a way that the short-and long-term objectives are fulfilled in a cost-effective way. It leverages the reward models to achieve the same. The policy that it learns maximizes long term and short-term reward objectives.

Checkpoints are generated for each of the models and stored for inference systems.

In operation of the Inference System/Pipeline 52, ingestion of service network metrics and service cluster metrics by the Metrics ingestion system, which includes metrics preprocessing and metrics transformations like format, datatypes and unit conversions, offsets, etc. The checkpoints of each AI model from the training pipeline 50 are loaded. By taking the real time metrics (states of the service networks and service clusters), the model picks the optimal weights for the topology in such a way that SLAs and Cost objectives are met. The system generates alerts and warnings based on the different metrics and criterion.

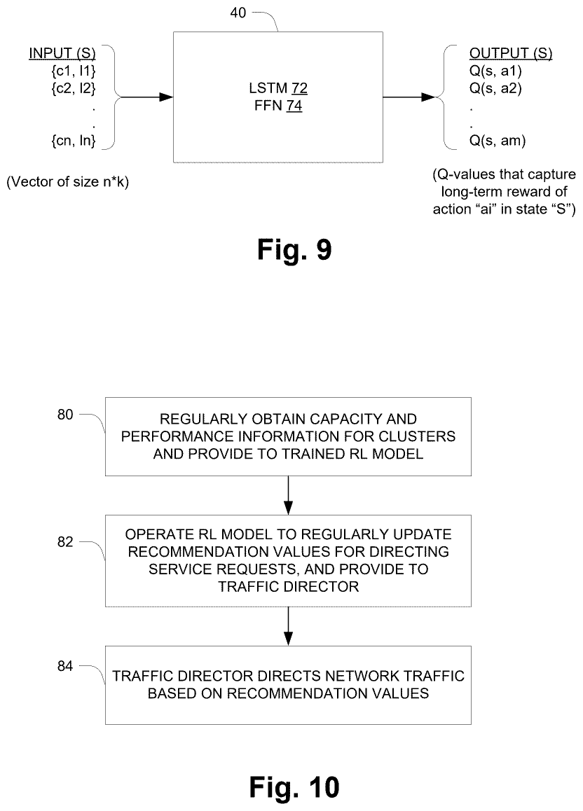

FIG. 9 shows another view of an RL-GLB 40. It includes one or more long short-term memory (LSTM) layers 72 and a feed-forward network (FFN) layer 74. Also shown are inputs and outputs for a given operating state S. Assuming “n” is the number of clusters and “k” is the number of metrics (e.g., CPU, latency etc.) that are tracked for each cluster, then the input to the RL algorithm 40 is a vector of length n*k. On the output side, assuming that there are “m” routing decisions (which may be based on required granularity), the outputs are a set of Q-values Q(S, ai), each capturing the long-term reward of taking action “ai” in state “S.”

The model 40 has two modes of operating, training, and inference (using the respective pipelines 50 and 52, described above). For training, a machine learning (ML) simulator is used that predicts the future configurations of each cluster 16 based on current configuration and number of jobs ({cx, 1x} for each cluster x). Given current-time parameters x_t, a function is built and trained that predicts next-time set of parameters x_{t+1}, i.e., x_{t+1}=f(x_t), where “f” is a feed-forward neural network.

Below is an example of sample training data for a cluster:

| S. No | CPU | Latency | Jobs |
|---|---|---|---|
| 1 | 0.7 | 40 | 100 |
| 2 | 0.8 | 45 | 200 |

Multiple samples of cluster metrics are collected from the simulator and used to train the model. Objectives of two distinct types may be used:
1. Threshold based: All the metrics of the clusters should not cross a prescribed threshold.
2. Closeness based: All the metrics of clusters should be similar, thereby ensuring a stable system.

Once the RL algorithm is sufficiently trained, the model is invoked with current parameters of the clusters 16 to decide the optimal action, i.e.:
Best routing strategy=\arg\max_a Q(s,a),
where “s” is the current configuration.

FIG. 10 is a high-level flow diagram of a method of directing network traffic to distribute client service requests among a set of service clusters (e.g., 16) of a service network. It includes, at 80, regularly obtaining respective capacity and performance information for each of the service clusters (e.g., cluster metrics as described above) and providing the information to a trained reinforcement-learning (RL) model (e.g., 40) that integrates learned request-distribution and reward information for the service network. At 82, the RL model is operated to regularly update recommendation values (e.g., weights) for directing the client service requests to the respective service clusters, and regularly providing updated recommendation values to a traffic director to influence traffic-directing thereby. In the example above, this takes the form of an RL-GLB of platform 20 sending updated weights to a DNS server 22, which functions as a traffic director by responding to DNS resolution requests according to current weight values for those clusters 16 that provide the service (or GPU/workload resources) corresponding to the URLs of the DNS requests. At 84, the traffic director (e.g., DNS server) directs network traffic at least partly based on the regularly provided updated recommendation values (e.g., by the weight-based response to DNS requests).

While various embodiments of the invention have been particularly shown and described, it will be understood by those skilled in the art that various changes in form and details may be made therein without departing from the scope of the invention as defined by the appended claims.

What is claimed is:

1. A method of directing network traffic to distribute client service requests among a set of service clusters of a service network, comprising:
regularly obtaining respective capacity and performance information for each of the service clusters and providing the information to a trained reinforcement-learning (RL) model that integrates learned request-distribution and reward information for the service network;
operating the RL model to regularly update recommendation values for directing the client service requests to the respective service clusters, and regularly providing updated recommendation values to a traffic director to influence traffic-directing thereby; and
by the traffic director, directing network traffic at least partly based on the regularly provided updated recommendation values.

2. The method of claim 1, wherein the regularly obtaining and the operating are performed in an RL platform including RL-GLB instances each having a training pipeline and an inference pipeline, the training pipeline having components including training models that are co-operative to train the RL model as well as other models of the inference pipeline based on historical values of ingested service network metrics and service cluster metrics, the inference pipeline including the RL model as well as additional models collectively operative to perform traffic and load predictions, data analysis to determine patterns, and generation of weight recommendations as the recommendation values.

3. The method of claim 1, wherein the reward information reflects a degree of meeting a service level agreement (SLA), including latency and errors, and cost objectives.

4. The method of claim 1, wherein the traffic director is a Domain Name System (DNS) server and the recommendation values are weight values reflecting respective current capacities of the service clusters for accepting service requests, the DNS server using the weight values to select among candidate service clusters for a given service when responding to a resolution requests for the given service, the selection being reflected in DNS responses that cause the service clients to direct the service requests to the selected service clusters accordingly.

5. The method of claim 4, wherein the weight values are calculated by respective dynamic traffic controllers (DTCs) of the service clusters which each monitor load of a service against configured resource constraints and dynamically adjusts the application weight according to how close an application is to reaching its maximum capacity.

6. The method of claim 5, wherein the DTCs use a weight calculation algorithm employing a range between a lower threshold and upper threshold, in which (1) below the lower threshold the service is to appear as “fully available”, (2) above the upper threshold the service is to be used only as a “last resort”, and (3) between the lower and upper thresholds relative weighting is used in which the weight value is based on current utilization of service cluster resources.

7. The method of claim 4, wherein the weight is calculated as a difference between a maximum value and a range-weighted measure of current usage above threshold.

8. The method of claim 5, wherein the weight values are calculated by deciding relative weight of each service cluster based on both long term and short-term service-level objectives (SLOs) and cost optimization.

9. The method of claim 4, wherein a given service is advertised from multiple service clusters, enabling the DNS server to load balance among the service clusters, and wherein (1) an association of a weight with a respective name/address mapping guides the DNS server to balance a distribution of its responses to favor one service cluster over another for one or more of the service requests, and (2) dynamically updating the weight based on service cluster loading allows the DNS server to steer more or less traffic to a given service cluster.

10. The method of claim 1, wherein the capacity and performance information are one or more of service metrics, application metrics, service cluster metrics, latency, cluster/service resource utilization, policies, data gravity, client/cluster geolocation info, governance, performance, custom policies, custom configuration.

11. The method of claim 10, wherein the capacity and performance information are ingested via one or more mechanisms selected from open telemetry, Prometheus, and Kubernetes state monitoring (KSM).

12. The method of claim 10, wherein the capacity and performance information are received from one or more third-party monitoring platforms as well as directly from the service clusters.

13. The method of claim 1, wherein the service clusters provide resources for executing respective workloads of types selected from CPU, database, HPC and GPU workloads, and the service requests are requests for deployment of the workloads on the service clusters.

14. The method of claim 1, wherein the service clusters are deployed across multiple regions, zones, and/or edge locations of a single cloud provider.

15. The method of claim 1, wherein the service clusters are deployed across multiple distinct cloud providers.

16. The method of claim 1, wherein the service clusters are deployed across multiple clouds and hybrid clouds including one or more of data centers, on-premises data centers, enterprise data centers/sites, edge clouds, edge data centers.

17. The method of claim 1, wherein the RL model is deployed on a smart global load balancing (GLB) platform deployed in one or more cloud environments or one or more data centers.

18. The method of claim 1, wherein the RL model receives as inputs a stream of two-valued samples including respective configurations of the service clusters and per-cluster number of jobs being handled by the respective service clusters, and generates an output stream of job-assignment values each specifying numbers of jobs to be assigned to respective service clusters.

19. A service network having a set of service clusters to deliver one or more services to a set of clients, the clients generating client service requests to be distributed among the set of service clusters in a load-balanced manner, the service network including a traffic director and RL-based platform executing a trained reinforcement-learning (RL) model that integrates learned request-distribution and reward information for the service network, the RL platform and traffic director being co-configured and co-operative to:
regularly obtain respective capacity and performance information for each of the service clusters and provide the information to the RL model;
operate the RL model to regularly update recommendation values for directing the client service requests to the respective service clusters, and regularly provide updated recommendation values to the traffic director to influence traffic-directing thereby; and
by the traffic director, direct network traffic at least partly based on the regularly provided updated recommendation values.

20. The service network of claim 19, wherein the RL platform includes RL-GLB instances each having a training pipeline and an inference pipeline, the training pipeline having components including training models that are co-operative to train the RL model as well as other models of the inference pipeline based on historical values of ingested service network metrics and service cluster metrics, the inference pipeline including the RL model as well as additional models collectively operative to perform traffic and load predictions, data analysis to determine patterns, and generation of weight recommendations as the recommendation values.
